(19) United States
(12) Patent Application Publication
(10) Pub. No.: US 2016/0105026 A1
(43) Pub. Date: Apr. 14, 2016

(54) DYNAMIC POWER DISTRIBUTION IN PHOTOVOLTAIC INSTALLATIONS

(71) Applicant: SMA Solar Technology AG, Niestetal (DE)

(72) Inventors: Kristo Lila, Tallinn (EE); Soren Baekhoj Kjaer, Harrislee (DE); Christian Harald Benz, Flensburg (DE); Wulf-Toke Franke, Harrislee (DE)

(21) Appl. No.: 14/974,792

(22) Filed: Dec. 18, 2015

Related U.S. Application Data
(63) Continuation of application No. PCT/IB2014/061197, filed on May 5, 2014.

(30) Foreign Application Priority Data
Jun. 19, 2013 (DK) 201300377

(51) Int. Cl. H02J 3/38; H02S 40/32

(52) U.S. Cl. CPC H02J 3/383; H02S 40/32

(57) ABSTRACT

The present disclosure relates to a photovoltaic power installation configured to deliver power to a consumer at a supply node, the power installation including a first power inverter configured to be connected to a first group of photovoltaic panels, a second power inverter configured to be connected to a second group of photovoltaic panels, a control unit, a data communication network interconnecting the first and second power inverters and the control unit. The control unit is configured to set output power references to the first and second power inverters of the photovoltaic power installation in accordance with available power levels from the first and second power inverters so as to deliver an output power level in accordance with an externally generated power reference at the supply node. The present disclosure further relates to an associated method

### CROSS REFERENCE TO RELATED APPLICATIONS

This application claims priority to International Patent Application number PCT/IB2014/061197, filed on May 5, 2014, which claims priority to Denmark Patent Application number 201300377, filed on Jun. 19, 2013, and is hereby incorporated by reference in its entirety.

### FIELD

The present disclosure relates to photovoltaic (PV) installations and associated methods for optimizing the power output of such PV installations for the benefit of the owners of such PV installations.

### BACKGROUND

Traditional power distribution grids receive power from power generating units and deliver it to power consumers. The roles of the power generator units were quite clearly to deliver power within certain parameters. However, as the complexity of power distribution grids increases, and the complexity of the characteristics of the many different types of power generating units continues to increase, there is an increasing need to support the existing power distribution grid with services which enable it to achieve efficient distribution.

A first example of such a service is the absorption of reactive power. A PV installation containing a plurality of power inverters is capable of supplying such a service.

A second example of such a service is based on the fact that a power distribution grid only distributes the power to the various power consumers. Energy cannot be stored on the power distribution grid and therefore the power generation and the power consumption sides must be balanced. This is normally achieved by commanding selected power generation units to change the power generated. This may result in the power generating unit or units generating power which is below the power level that they are capable of generating, or return to a higher level from a previously commanded lower level. This kind of limiting is normally referred to as power level adjustment (PLA), and is often specified as a given percentage of the rated power of the power generating unit.

When a traditional PV installation containing a plurality of power inverters receives a PLA limitation from a grid operator, this limitation may be applied to all the power inverters within the installation. Thus, according to known PV installations, a received PLA limitation may be applied globally within the installation. By applying this technique, unnecessary power limitations may be put onto the PV installations. This power limitation is certainly not in the interest of the owners of the PV installations.

Other services, based on changing other characteristics of the output of power generation units, may also be available.

### SUMMARY

Advantages of the approach described here include the ability of optimization in case of unequal irradiated strings and PLA, the availability of a higher yield/avoiding yield loss in case of limitation, which in turn leads to the opportunity of operating the PV installation at higher yield, and the possibility of running one or more PV strings at a higher or lower voltage, and thereby enabling the opportunity of running without a booster and/or deactivate the one or more PV strings or feed power generated into a storage device.

It may be seen as an embodiment of the present disclosure to provide a control scheme and apparatus for optimizing one or more characteristics of the output of PV installations for the benefit of the owners of PV installations.

The above-mentioned object is complied with by providing, in a first aspect, a photovoltaic power installation configured to deliver power to a consumer at a supply node. The power installation comprises a first power inverter operatively connected to a first group of photovoltaic panels, a second power inverter operatively connected to a second group of photovoltaic panels, and a control unit. The power installation further comprises a data communication network interconnecting the first and second power inverters and the control unit, wherein the control unit is configured to set output power references to the first and second power inverters of the photovoltaic power installation in accordance with available power levels from the first and second power inverters so as to deliver an output power level in accordance with an externally generated power reference at the supply node.

By a consumer is meant an apparatus or system which is connected to the photovoltaic power installation via the supply node, and which may at times absorb power generated by the photovoltaic power installation and which may at other times supply reactive power to the photovoltaic power installation. A consumer may be a public power distribution grid or it may be a privately owned power distribution grid. Alternatively it may comprise a basic, small installation operated as an ‘island’.

By ‘supply node’ is meant a point in a circuit where parameters such as power, reactive power, current, voltage or other measurable quantities are measured directly or estimated by modelling, remote measurements or by other means. Such a supply node may comprise a connection to a power distribution network, and may further comprise a point of common coupling (PCC). Alternatively, it may comprise a centralized point in a network.

The control unit may be integrated into the first power inverter so that it shares a common housing, or that the first power inverter is designed to be able to replicate the processes of the control unit so that the first power inverter itself can act as the control unit.

The first power inverter may be configured as a master power inverter, whereas the second power inverter may be configured as a slave power inverter.

The externally generated power reference may involve a PLA limit given in percentage of a rated power level of the installation. Alternatively, it may be an absolute value, fixed value or a dynamic value. This PLA limit may be provided by a grid operator. It is essential to the present disclosure that the externally generated power reference is given with reference to the supply node. That is to say the power delivered from the photovoltaic power installation into the grid at the supply node is the power that the grid operator requires to be limited.

Generally, the externally generated power reference may be provided as a fixed value, a dynamic value, an absolute value or a relative value. The value of the power reference may be based on Standard Test Conditions (STC) of the PV panels, or it may be based on nominal power, name-plate power or acquired measured power or the contractually agreed power or the available power at the time when the PLA signal came. Moreover, the power reference may be a value by schedule. Finally, the power reference may be a value set through Man Machine Interface (MMI) such as display, PC, Tablet, phone, etc.

For example if the first and second power inverters are both 10 kW inverters and a PLA limit of 50% is provided by the grid operator while the first power inverter is generating 8 kW and the second power inverter is generating 2 kW a total of 10 kW (8 kW from the first power inverter and 2 kW from the second power inverter) is delivered to the grid at the supply node.

Additional slave power inverters being operatively connected to respective groups of photovoltaic panels may optionally be provided. Each of the additional slave power inverters may be controllable by the master power inverter, or the control unit, via the data communication network.

The data communication network may be of the type involving an Ethernet-based or a wireless network. Other types of applicable networks may involve networks such as RS485, ZigBee®, Bluetooth®, Z-Wave® etc.

The master power inverter, or the control unit, may be configured to provide output power references to the additional slave power inverters as well.

At least part of the power inverters may be DC/AC power inverters adapted to convert DC power from the photovoltaic panels to AC power having an appropriate voltage level and frequency in order to match the characteristics of the supply node.

In a second aspect the present disclosure relates to a method for operating a photovoltaic power installation configured to deliver power to a consumer at a supply node. The method comprises
providing a first power inverter operatively connected to a first group of photovoltaic panels, and providing a second power inverter operatively connected to a second group of photovoltaic panels. The method further comprises providing a control unit, the first and second power inverters and the control unit being interconnected by a data communication network. The control unit sets output power references for the first and second power inverters of the photovoltaic power installation in accordance with available power levels from the first and second power inverters so as to deliver an output power level in accordance with an externally generated power reference at the supply node.

The control unit may be integrated into the first power inverter so that it shares a common housing, or so that the first power inverter is designed to be able to replicate the processes of the control unit so that the first power inverter itself can act as the control unit.

The setting of the output power references may be implemented in accordance with embedded software running on the first power inverter which may be configured as a master power inverter adapted to control the second power inverter which may be configured as a slave power inverter. Additional slave power inverters operatively connected to respective groups of photovoltaic panels may be provided as well. Each of the additional slave power inverters may be controlled by the master power inverter, or the control unit, via the data communication network. The master power inverter, or the control unit, may provide output power references to the additional slave power inverters via the data communication network.

As mentioned above the externally generated power reference may be provided by an operator of the consumer. The power reference itself may take the form of a PLA or any other of the above-mentioned formats. Thus, the externally generated power reference may limit the output power level of the photovoltaic power installation to a sub-nominal output power level of the installation at the supply node. The sub-nominal output power level of the photovoltaic installation may be achieved by operating a number of power inverters in accordance with available power levels from the power inverters and respective photovoltaic panels operatively connected thereto.

The available power levels from the power inverters may vary over time. Similarly, the power inverters may generate different levels of power.

### BRIEF DESCRIPTION OF THE DRAWINGS

The present disclosure will now be explained in further details with reference to the accompanying figures:

FIG. 1 shows a PV power installation according to the present disclosure comprising a control unit,

FIG. 2 shows a PV power installation according to the present disclosure in which the control unit functions are integrated in one inverter,

FIG. 3 shows a PV power installation comprising a single inverter with multiple PV strings, and

FIG. 4 shows a PV power installation comprising multiple inverters.

While the disclosure is susceptible to various modifications and alternative forms, a specific embodiment has been disclosed by way of an example. It should be understood, however, that the disclosure is not intended to be limited to the particular form disclosed. Rather, the disclosure is to cover all modifications, equivalents, and alternatives falling within the spirit and scope of the disclosure as defined by the appended claims.

### DETAILED DESCRIPTION OF THE DISCLOSURE

In its broadest aspect the present disclosure relates to a PV installation and a method for operating a PV installation in order to provide maximum yield to the owner of the installation when constraints on production are being demanded by the consumer, for example during periods of power curtailment (that is, when a PLA is applied), or when the exchange of reactive power is being requested. In particular, for example, an inverter that is partially shadowed (and therefore is not operating at capacity) can be used as a sink of reactive power because it has significant capacitive resources.

While the description that follows describes the distribution of constraints (such as power curtailment) between inverters in a PV installation, it should be remembered that such distribution can also take place between strings attached to a particular inverter. This means that a single inverter that is fed by two or three strings could treat those strings in the same way that the plant controller treats individual inverters.

For example, in an embodiment of the current disclosure a photovoltaic installation comprising a plurality of power inverters and designed to maximize yield during periods of power curtailment (that is, when PLA is applied), one of the power inverters is set to be a master power inverter within the network. This power inverter is adapted to continuously monitor the PLA for changes. When such a change is detected, a new maximum output power level for the PV installation is calculated by taking the sum of the rated maximum output power of the power inverters in the network and multiplying this sum with the provided PLA percentage.

The challenge here is that it is difficult to estimate how much a given power inverter would produce if there was no PLA limit at all. Several methods are available, including the use of a radiation sensor to estimate the available radiation. Alternatively, a full maximum power point sweep may be done by the maximum power point tracking facilities of the individual inverters. Another alternative is that one (or more) inverter(s) may be left unchanged/unaffected by changes in response to the PLA and used as a “radiation sensor”. Account needs to be taken of any PV modules that are malfunctioning or offline due to maintenance. Such an estimation has to be performed on a continuous basis since the output level may change constantly.

An alternative is the control algorithm described below which may run on the master power inverter, or in the control unit, at intervals, for example, between 5 minutes and 1 second and in another example between 30 seconds and 3 seconds. Firstly, data is collected from all the power inverters within the network. Particularly, information relating to the rated power levels of the power inverters, the current output power level of the inverters and the current PLA limit are collected. Using this information the current total output power level of the PV installation is calculated.

Based on the provided PLA, the following two scenarios may occur:
1. The PV installation is generating more power than allowed, or
2. The PV installation is generating less power than allowed.
   In the following, the two above-mentioned scenarios are disclosed separately.
   The PV Installation is Generating More Power than Allowed:

In this case the algorithm starts turning down PLA levels on power inverters, following a prearranged sequence including all the inverters, in order to reduce power. The process is stopped when the expected output power level will be in line with the required output power level. After this the new PLA settings are distributed to all inverters. This ensures that the time during which the PV installation is generating an excess of power is limited as much as possible.

The PV Installation is Generating Less Power than Allowed

In this scenario the control algorithm takes an iterative approach, and for each power inverter the algorithm first determines if the power inverter's production can be increased.

The conditions for this are as follows:

the inverter currently has an individual PLA limit of less than 100%. (An individual PLA that is applied to the particular power inverter)

The difference between the required output limit and the actual output may then be evenly divided among the power inverters whose production could be increased. It would be possible to discover which inverters can increase their production by conducting a full maximum power point sweep and communicating this to the master power inverter, or control unit, for use in the current algorithm. The production capabilities of an individual inverter change slowly with time, but such a sweep need only be conducted at intervals, for example, between 1 hour and 5 minutes and in another example between 30 minutes and 10 minutes.

The control algorithm continues by iterating over all of the power inverters within the installation, attempting to increase the limit of a given power inverter by, for example, 60%. The reason for this being that it should be avoided that the power production of the PV installation varies in a rapid manner. Moreover, the limit should not be set too high. The power generation will not increase immediately to the required level. Typically it will take 3-4 iterations before reaching the limit. This relative slow response stabilizes the controller whereby power fluctuations of the power inverters are damped. When the PLA values for all power inverters have been calculated by the master inverter, or the control unit, they are then distributed to the power inverters in the network of the PV installation. Thus, only after the calculations are completed are the required PLA values sent to the real inverters.

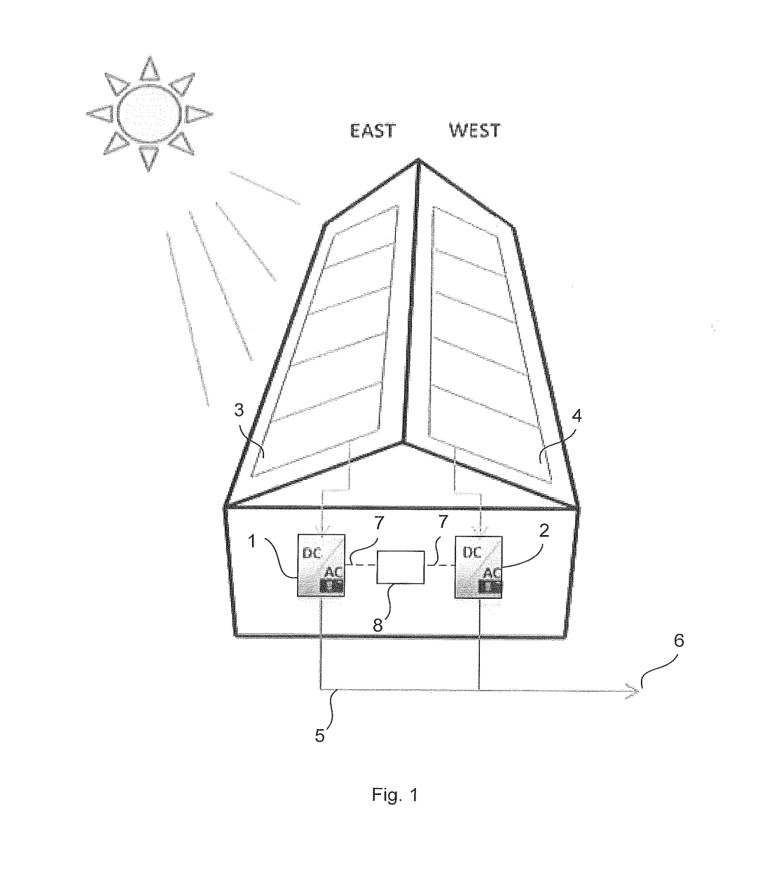

Referring now to FIG. 1 a PV power installation is depicted. The exemplifying embodiment shown in FIG. 1 shows an installation comprising two power inverters 1, 2 and a control unit 8. Each power inverter is operatively connected to an array of solar panels 3, 4 arranged on the roof of a building. During operation DC power from the solar panels is converter to AC power and fed onto an internal grid 5 before reaching the PCC 6.

Still referring to FIG. 1 an exemplifying control scheme is illustrated in Table 1.

TABLE 1

| | Inverter 1 | Inverter 2 | Total |
|---|---|---|---|
| Inverter size (kW) | 10 | 10 | 20 |
| Power level adjustment (PLA) | 60% | | |
| Maximum allowed inverter output | 6 | 6 | 12 |
| (kW) | | | |
| Current maximum output power - | 8 | 4 | 12 |
| example (kW) | | | |
| with prior art method (kW) | 6 | 4 | 10 |
| with inventive method (kW) | 8 | 4 | 12 |

The power inverters of FIG. 1 both have a capacity of 10 kW yielding a total capacity of the PV installation of 20 kW. In the present example a PLA limit of 60% is provided by a grid operator. Applying this limit to both power inverters a maximum total power production of 12 kW may be established. However, in case inverter 1 is capable of generating 8 kW and inverter 2 is limited to 4 kW a total of only 10 kW is available for the grid in the case that the PLA limit is applied to each power inverter as suggested by prior art methods. In Table 1 this is denoted “with prior art method”, where “with inventive method” is the method herein described. By applying the principle of the present disclosure, where a given PLA limit is applied at the PCC, a total power level of 12 kW can be reached.

Thus, in the above-mentioned example a 20% increase in power supplied to the grid may be gained by applying the principle of the present disclosure compared to prior art methods.

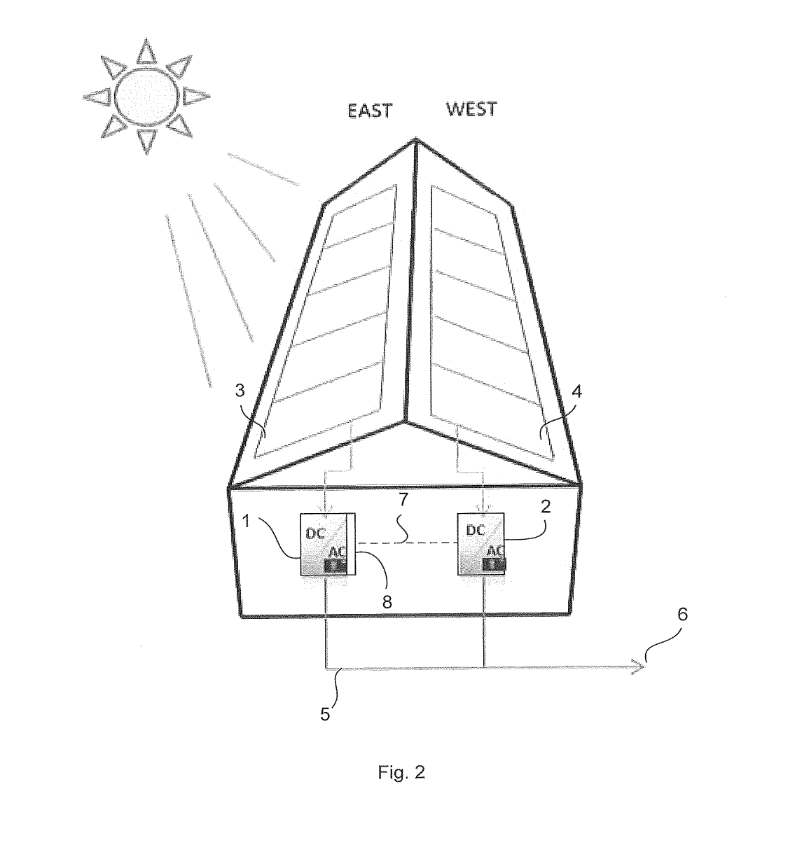

Referring now to FIG. 2, a PV power installation of a second embodiment is depicted. The embodiment shown in FIG. 2 shows an installation comprising two power inverters 1, 2 where one of the power inverters is configured as a master power inverter 1 and has the control unit 8 integrated. The other power inverter 2 acts like a slave inverter configured to be controlled by the master power inverter 1 as explained above. Apart from this difference, the method is as described above.

Further embodiments will now be described in which the inventive concepts are applied firstly to active power on string level of the same inverter, secondly to reactive power provision within a power plant between PV inverters, and finally the inventive concepts are applied to reactive power provision within a power plant between different components such as active filters and PV inverters.

### a) Active Power on String Level of the Same Inverter.

The PLA signal and any other ancillary service is valid at AC side, normally at the PCC. In a traditional approach the PLA is distributed to the DC side. The PLA is divided by the number of strings and the value is communicated as an equal limitation to each string.

However, it may be possible to analyze the capability of each string by use of the IV curve and access to the maximum power point tracker (MPPT) algorithm. A limitation could thereby be distributed in a more intelligent way. Additionally or alternatively, a single string may be used as a sensor for determining the available power and then the power provided by the other strings may be appropriately adjusted.

### Example 1 for Active Power on String Level of the Same Inverter

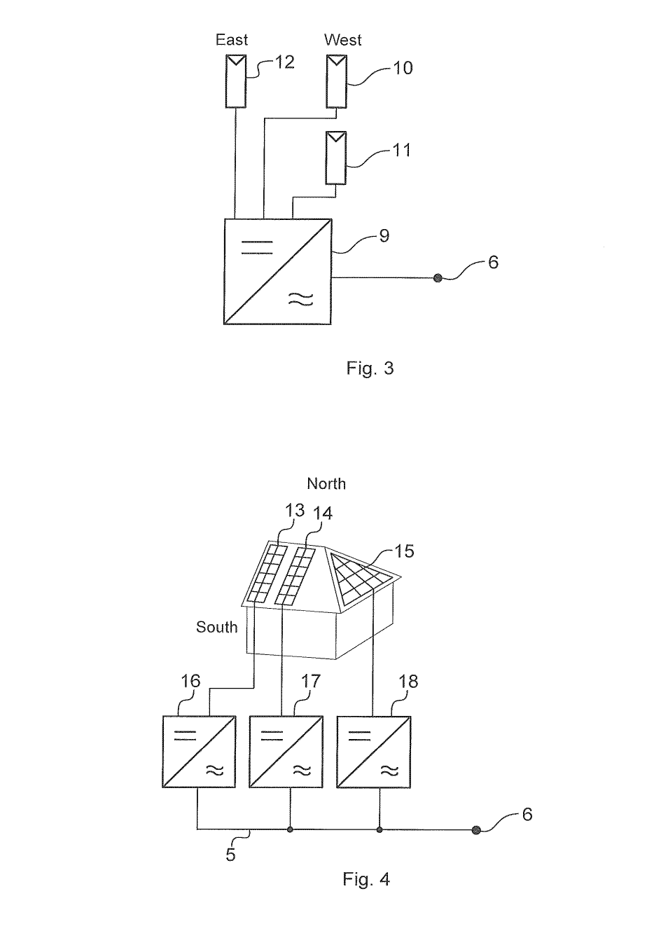

Assuming a PV system as shown in FIG. 3, with a three string layout (e.g. 2 strings 10, 11 in west with nominal power west of 12 kW each and one string 12 in east with a nominal power of 4 kW) connected to an inverter 9 with 3 MPP trackers and 15 kVA nominal power. At a particular time, the western strings are able to generate 9216 W (at 768 V) and the eastern string is able to generate 544 W (at 544 V), a total of 9.760 kW. A PLA is applied of 60% (60% of nominal power 15 kW=9 kW).

A traditional approach would be as follows. Given a PLA of 9 kW, this would be divided by 3 (number of active strings), resulting in maximum power intake from each string to 3 kW. Overall power produced would thereby be limited to 6.544 kW (2×3 kW from west; 1×544 W from east).

The new approach would identify, for example by conducting an exploration of the IV curve of the strings, the individual available powers and thereby the optimal string to limit. The algorithm, knowing the bypass voltage around 700 Vdc, would, in this example, move the point of operation of the two west strings into an optimal range where e.g. the booster could be still bypassed (e.g. the reference voltage for the DC link=700V) and limit the shorter string by the inherently higher DC voltage and stopping the booster to zero. In this way the full PLA of 9 kW can be achieved, and the yield loss of

9 kW−6.544 kW=2.456 kW

is avoided.

Due to the existence of separate inputs (booster/MPP tracker) a current flowing backwards into the modules is prevented. A new sweep to update the IV curve of a particular string may be triggered either at regular intervals or by a change in conditions, e.g. the output power falling below the limit.

### b) Reactive Power Provision Within a Power Plant Between PV Inverters.

Another reason for limitation may be a reactive power provision which could be optimized in different ways within the plant. For example by the provision by one inverter for the whole plant, instead of the provision being divided among every inverter. In the case that there is a need to limit active power on one inverter, the limitation may be applied following the more intelligent principles in a similar manner to that used for PLA described above. The aim is to use the free reserve which may be available in some of the inverters, if they are not already generating full active power.

### Example 2a—The Provision by a Selected Inverter for the Complete Plant

A plant, as illustrated by way of example in FIG. 4, with 3×15 kW capacity inverters 16, 17, 18 whereby two inverters 16, 17 have all PV modules 13, 14 facing south, and one inverter 18 is fed by PV modules 15 covering other sections of the roof. Production of active power by the south-facing inverters is 14 kW each, and increasing, whereby production from the other roof sections is at 10 kW. The resultant total active power (P) is 38 kW.

| | | Available | |
|---|---|---|---|
| | Maximum | active | Maximum provision |
| | power | power from | of reactive power, |
| Inverter | capability | generator | without curtailing |
| # | [kVA] | [kW] | active power [kVAr] |
| 16 | 15.0 | 14.0 | 5.39 |
| 17 | 15.0 | 14.0 | 5.39 |
| 18 | 15.0 | 10.0 | 11.18 |
| Total | 45.0 | 38.0 | 21.96 |

Reactive power e.g. remote command and continuous operation of cos(φ)=0.90 which is in this example equivalent to an apparent power (S) of

$$S = \frac{P}{cos ( ϕ )} = \frac{38}{cos ( ϕ )} = 42.22 kVA$$

resulting in Q (reactive power):

Q=\sqrt{(S²−P²)}={square root over ((42.22k)²−(38k)²))}=18.4 kVAr

A traditional approach would be as follows. Communicate the Power Factor (PF)=P/S=cos(φ)=0.90 to all inverters 16, 17, 18, resulting in limitation to 13.5 kW active power (0.9×15 kW) for the two southern inverters 16, 17 and no limitation (yet) for the remaining inverter 18.

| | | Available | | | |
|---|---|---|---|---|---|
| | Maximum | active | | Active | Reactive |
| | power | power from | | power | power |
| Inverter | capability | generator | PF set- | generation | generation |
| # | [kVA] | [kW] | point | [kW] | [kVAr] |
| 16 | 15.0 | 14.0 | 0.90 | 13.5 | 6.54 |
| 17 | 15.0 | 14.0 | 0.90 | 13.5 | 6.54 |
| 18 | 15.0 | 10.0 | 0.90 | 10.0 | 4.84 |
| Total | 45.0 | 38.0 | 0.90 | 37.0 | 17.92 |

Power lost due to curtailment is (available active power from generator) minus (active power generation):

38.0 kW−37.0 kW=1.0 kW.

Another approach is to communicate a common set-point for the reactive power to each inverter. In the normal case: 18.4 kVAr/3=6.1 kVAr:

| | | Available | | | |
|---|---|---|---|---|---|
| | Maximum | active | | Active | |
| | power | power from | Q set- | power | |
| Inverter | capability | generator | point | generation | Obtained |
| # | [kVA] | [kW] | [kVAr] | [kW] | PF |
| 16 | 15.0 | 14.0 | 6.1 | 13.7 | 0.91 |
| 17 | 15.0 | 14.0 | 6.1 | 13.7 | 0.91 |
| 18 | 15.0 | 10.0 | 6.1 | 10.0 | 0.85 |
| Total | 45.0 | 38.0 | 18.3 | 37.4 | 0.90 |

Power lost due to curtailment is (available active power from generator) minus (active power generation):

38.0 kW−37.4 kW=0.6 kW.

The new approach would be as follows. Calculate the available reactive power capability in this case

2×Q=2*\sqrt{(15²−14²)}=2×5.39=10.77 kVAr

for the south-facing inverters and

1×Q=\sqrt{(15²−10²)}=11.18 kVAr

for the other inverter.

| | | Available | Available | | |
|---|---|---|---|---|---|
| | Maximum | active | Reactive | Reactive | Active |
| | power | power from | power | power set- | power |
| Inverter | capability | generator | generation | point | generation |
| # | [kVA] | [kW] | [kVAr] | [kVAr] | [kW] |
| 16 | 15.0 | 14.0 | 5.39 | 5.39 | 14.0 |
| 17 | 15.0 | 14.0 | 5.39 | 5.39 | 14.0 |
| 18 | 15.0 | 10.0 | 11.18 | 7.62 | 10.0 |
| Total | 45.0 | 38.0 | 21.95 | 18.4 | 38.0 |

Power lost due to curtailment is (available active power from generator) minus (active power generation):

38.0 kW−38.0 kW=0.0 kW.

In case of needed curtailment among others the above described PLA solution can be applied to identify the optimal way of curtailment.

### Example 2b—Limitation on a Single Inverter

Taking the framework situation of the plant illustrated in FIG. 3 and applying, instead of a PLA, a remote requirement for reactive power equivalent of:

Q=12 kVAr=\sqrt{(15k)²−(9k)²}

which by the way equals a cos φ=0.6 at full power.
The needed limitation of active power would be the same as in Example 1 also with avoided yield loss approximately 2.456 kW.

### c) Reactive Power Provision Within a Power Plant Between Different Components Such as Active Filters and PV Inverters

A novel approach is similar to Example 2 described above, with the difference that the ancillary services are not delivered by PV inverters but separate power electronics components such as active filters. This approach differs from applying fixed compensators such as capacitors or chokes. Such an approach is used within the wind power industry and is known by the designation ‘flexible AC transmission system’ or ‘FACTS’.

We claim:

1. A photovoltaic power installation configured to deliver power to a consumer at a supply node, the power installation comprising:
a first power inverter configured to be connected to a first group of photovoltaic panels;
a second power inverter configured to be connected to a second group of photovoltaic panels;
a control unit; and
a data communication network interconnecting the first and second power inverters and the control unit,
wherein the control unit is configured to set output power references for the first and second power inverters of the photovoltaic power installation in accordance with available power levels from the first and second power inverters so as to deliver an output power level in accordance with an externally generated power reference at the supply node.

2. A photovoltaic power installation according to claim 1, wherein the consumer is a power distribution grid.

3. A photovoltaic power installation according to claim 1, wherein the supply node is a point of common coupling.

4. A photovoltaic power installation according to claim 1, wherein the control unit is integrated into the first power inverter.

5. A photovoltaic power installation according to claim 1, wherein the first power inverter is configured as a master power inverter, and wherein the second power inverter is configured as a slave power inverter.

6. A photovoltaic power installation according to claim 5, further comprising additional slave power inverters configured to be connected to respective groups of photovoltaic panels, wherein each of the additional slave power inverters is controllable by the master power inverter or the control unit via the data communication network.

7. A photovoltaic power installation according to claim 6, wherein the master power inverter or the control unit is configured to provide output power references to the additional slave power inverters.

8. A method for operating a photovoltaic power installation configured to deliver power to a consumer at a supply node, the method comprising:
providing a first power inverter configured to be connected to a first group of photovoltaic panels;
providing a second power inverter configured to be connected to a second group of photovoltaic panels; and
providing a control unit, the first and second power inverters and the control unit being interconnected by a data communication network,
wherein the control unit sets output power references for the first and second power inverters of the photovoltaic power installation in accordance with available power levels from the first and second power inverters so as to deliver an output power level in accordance with an externally generated power reference at the supply node.

9. A method according to claim 8, wherein the consumer is a power distribution grid.

10. A method according to claim 8, wherein the supply node is a point of common coupling.

11. A method according to claim 8, wherein the control unit is integrated into the first power inverter.

12. A method according to claim 8, wherein the first power inverter, which is configured as a master power inverter, or the control unit, controls the second power inverter which is configured as a slave power inverter.

13. A method according to claim 12, further comprising additional slave power inverters configured to be connected to respective groups of photovoltaic panels, wherein each of the additional slave power inverters is controlled by the master power inverter, or the control unit, via the data communication network.

14. A method according to claim 13, wherein the master power inverter, or the control unit, provides output power references to the additional slave power inverters.

15. A method according to claim 14, wherein the externally generated power reference is provided by an operator of the power distribution grid.

16. A method according to claim 15, wherein the externally generated power reference limits the output power level of the photovoltaic power installation to a sub-nominal output power level of the installation.

17. A method according to claim 16, wherein the sub-nominal output power level of the photovoltaic installation is achieved by operating a number of power inverters in accordance with available power levels from the power inverters and respective photovoltaic panels operatively connected thereto.

18. A method according to claim 17, wherein the available power levels from the power inverters vary over time.

19. A method according to claim 8, wherein the power inverters generate different levels of power.
